(19) United States
(12) Patent Application Publication
(10) Pub. No.: US 2018/0362809 A1
(43) Pub. Date: Dec. 20, 2018

(54) POLYESTER-ISOCYANATE COATINGS AND LABELS INCLUDING THE SAME

(71) Applicant: Avery Dennison Corporation, Glendale, CA (US)

(72) Inventors: Shuhui XIE, Glendale, CA (US); Yuanhua ZHU, Glendale, CA (US); Hang WU, Glendale, CA (US)

(73) Assignee: Avery Dennison Corporation, Glendale, CA (US)

(21) Appl. No.: 16/009,489

(22) Filed: Jun. 15, 2018

Related U.S. Application Data
(63) Continuation of application No. PCT/CN2017/089157, filed on Jun. 20, 2017.

(51) Int. Cl. C09J 7/29; C09J 7/40; C09J 7/38

(52) U.S. Cl. CPC C09J 7/29; C09J 7/40; C09J 7/38; C09J 2477/003; C09J 2467/006; C09J 2467/003; C09J 2479/086

(57) ABSTRACT

Polyester-isocyanate coatings that exhibit desirable heat resistance and adhesion to a variety of polymeric materials and labels including such coatings are provided. The polyester-isocyanate compounds present within the coatings can be obtained by reacting an isocyanate and a hydroxylated polyester. The coatings may be applied to labels and have reduced curling tendency while having improved thermal transfer printability, heat resistance, chemical resistance, scratch resistance, and wave soldering resistance.

### FIELD OF THE INVENTION

The present invention relates generally to polyester-isocyanate coatings that exhibit heat resistance and adhesion to a variety of polymeric materials. The present invention also relates to labels including such polyester-isocyanate coatings.

### BACKGROUND OF THE INVENTION

Electronic equipment manufacturers benefit from automated assembly, processing, and test and packaging systems which include automatic identification. For instance, labels including barcodes printed thereon are typically adhered to a printed circuit board (PCB) before soldering to provide for automatic identification. These labels must withstand harsh thermal and chemical exposures and still meet optical requirements for reliable scanning.

U.S. Pat. No. 5,958,537 discloses static dissipative labels with a polyester or polyimide backing film laminated to a conductive primer layer which is in turn laminated to a pressure-sensitive adhesive layer. The primer layer and adhesive layer contain conductive particles, e.g., metals, and the conductive particles in the adhesive layer are arranged such that they span the thickness of the layer.

U.S. Pat. No. 6,120,883 discloses a printable coating which is opaque as well as scratch resistant. The coating contains a resin as a binder and titanium dioxide and boron nitride as a filler. The resultant coated film product can be used in various chemically and thermally demanding applications such as printed circuit board bar-code labels, wave solder masking tapes, automotive labels, and electrical insulation.

US Publication No. 2015/0037572 discloses a surface protective film which has a substrate having a topcoat layer containing a lubricating property-imparting component and an adhesive layer formed of a water dispersible acrylic adhesive composition, which has a resistance to whitening and excellent removability. A surface protective film has: a substrate, a topcoat layer and an acrylic adhesive layer formed on respective faces of the substrate. The topcoat layer contains a lubricant wax composed of a higher fatty acid/higher alcohol ester and a polyester binder resin. The acrylic adhesive layer is formed of a water dispersible acrylic adhesive composition containing an acrylic emulsion polymer obtained by polymerization of an alkyl (meth)acrylate (A) and a carboxyl group-containing unsaturated monomer (B) with a reactive emulsifier.

US Publication No. 2015/0179089 discloses polyester-melamine coatings and labels comprising the polyester-melamine coating as a topcoat layer.

The need still exists for a topcoat layer having reduced curling tendency while also having improved thermal transfer printability, heat resistance, chemical resistance, scratch resistance, and wave soldering resistance. The present invention includes improved coatings for a label (e.g, PCB labels) that withstand elevated temperatures, exhibit resistance to many common solvents, and are receptive to printing (e.g., thermal transfer printing).

### BRIEF SUMMARY OF THE INVENTION

In one embodiment, the present disclosure is directed to a label comprising: (i) a facestock comprising a polymeric film, the polymeric film having a top surface and a bottom surface; and (ii) a topcoat layer comprising one or more polyester-isocyanate compounds, wherein the polyester-isocyanate compound has a cross-linking density from 0.9 to 1.4, and said topcoat layer being positioned proximate and/or directly adjacent to at least a portion of the top surface of the polymeric film. The topcoat layer may have a thickness of from about 2 to about 100 μm. The topcoat layer may be directly adjacent said top surface of said polymeric film. The label may further comprise an adhesive layer positioned at least one of proximate or adjacent to at least a portion of the bottom surface of the polymeric film. The adhesive layer may be directly adjacent said bottom surface of said polymeric film. The label may further comprise a releasable liner positioned adjacent said adhesive layer such that said adhesive layer is disposed directly or indirectly between said bottom surface of said polymeric film and said releasable liner. The adhesive layer may comprise a pressure sensitive adhesive. The polymeric film may comprise a material selected from the group consisting of a polyimide, a polyester, a polyetherimide (PEI), a polyethylene naphthalate (PEN), a polyether sulfone (PES), a polysulfone, polymethylpentene (PMP), a polyvinylidenefluoride (PVDF), an ethylene-chlorotrifluoroethylene (ECTFE), or combinations thereof. In some aspects, the polymeric film may comprise at least one polyimide. The polymeric film may comprise at least one facestock polyester. The one or more polyester-isocyanate compounds may comprise the reaction product of an isocyanate and a hydroxylated polyester. The hydroxyl value of the hydroxylated polyester may be greater than 5 mg KOH/g. The hydroxylated polyester may comprise a hydroxyl group-terminated linear or branched polyester. The hydroxylated polyester may have a number average molecular weight of greater than 2000. The topcoat layer may be receptive to or support thermal transfer printing. The label may comprise printed indicia. The printed indicia may comprise a barcode. The topcoat layer may comprise at least one pigment. The topcoat layer may comprise at least one antioxidant. The topcoat layer may comprise at least one matting agent. The matting agent may have an average particle size of less than 10 microns or less than 5 microns.

In another embodiment, the present disclosure is directed to a form, comprising: (i) a plurality of labels; and (ii) a carrier sheet, said plurality of labels releasably adhered to the carrier sheet. The topcoat layer may have a thickness of from about 2 to about 100 μm. The topcoat layer may be directly adjacent said top surface of a polymeric film. The label may further comprise an adhesive layer positioned at least one of proximate or adjacent to at least a portion of the bottom surface of the polymeric film. The adhesive layer may be directly adjacent said bottom surface of said polymeric film. The label may further comprise a releasable liner positioned adjacent said adhesive layer such that said adhesive layer is disposed directly or indirectly between said bottom surface of said polymeric film and said releasable liner. The adhesive layer may comprise a pressure sensitive adhesive. The polymeric film may comprise a material selected from the group consisting of a polyimide, a polyester, a polyetherimide (PEI), a polyethylene naphthalate (PEN), a polyether sulfone (PES), a polysulfone, polymethylpentene (PMP), a polyvinylidenefluoride (PVDF), an ethylene-chlorotrifluoroethylene (ECTFE), or combinations thereof. In some aspects, the polymeric film may comprise at least one polyimide. The polymeric film may comprise at least one facestock polyester. The one or more polyester-isocyanate compounds may comprise the reaction product of an isocyanate and a hydroxylated polyester. The hydroxyl value of the hydroxylated polyester may be greater than 5 mg KOH/g. The hydroxylated polyester may comprise a hydroxyl group-terminated linear or branched polyester. The hydroxylated polyester may have a number average molecular weight of greater than 2000. The topcoat layer may be receptive to or support thermal transfer printing. The label may comprise printed indicia. The printed indicia may comprise a barcode. The topcoat layer may comprise at least one pigment. The topcoat layer may comprise at least one antioxidant. The topcoat layer may comprise at least one matting agent. The matting agent may have an average particle size of less than 10 microns or less than 5 microns.

In another embodiment, the present disclosure is directed to a continuous roll of labels, comprising: (i) a plurality of labels; and (ii) a carrier layer; said plurality of labels are releasably adhered to said carrier layer. The topcoat layer may have a thickness of from about 2 to about 100 μm. The topcoat layer may be directly adjacent a top surface of a polymeric film. The label may further comprise an adhesive layer positioned at least one of proximate or adjacent to at least a portion of the bottom surface of the polymeric film. The adhesive layer may be directly adjacent said bottom surface of said polymeric film. The label may further comprise a releasable liner positioned adjacent said adhesive layer such that said adhesive layer is disposed directly or indirectly between said bottom surface of said polymeric film and said releasable liner. The adhesive layer may comprise a pressure sensitive adhesive. The polymeric film may comprise a material selected from the group consisting of a polyimide, a polyester, a polyetherimide (PEI), a polyethylene naphthalate (PEN), a polyether sulfone (PES), a polysulfone, polymethylpentene (PMP), a polyvinylidenefluoride (PVDF), an ethylene-chlorotrifluoroethylene (ECTFE), or combinations thereof. In some aspects, the polymeric film may comprise at least one polyimide. The polymeric film may comprise at least one facestock polyester. The one or more polyester-isocyanate compounds may comprise the reaction product of an isocyanate and a hydroxylated polyester. The hydroxyl value of the hydroxylated polyester may be greater than 5 mg KOH/g. The hydroxylated polyester may comprise a hydroxyl group-terminated linear or branched polyester. The hydroxylated polyester may have a number average molecular weight of greater than 2000. The topcoat layer may be receptive to or support thermal transfer printing. The label may comprise printed indicia. The printed indicia may comprise a barcode. The topcoat layer may comprise at least one pigment. The topcoat layer may comprise at least one antioxidant. The topcoat layer may comprise at least one matting agent. The matting agent may have an average particle size of less than 10 microns or less than 5 microns.

In another embodiment, the present disclosure is directed to a printed circuit board comprising a label adhered to at least one surface of the printed circuit board. The topcoat layer may have a thickness of from about 2 to about 100 μm. The topcoat layer may be directly adjacent said top surface of said polymeric film. The label may further comprise an adhesive layer positioned at least one of proximate or adjacent to at least a portion of the bottom surface of the polymeric film. The adhesive layer may be directly adjacent said bottom surface of said polymeric film. The label may further comprise a releasable liner positioned adjacent said adhesive layer such that said adhesive layer is disposed directly or indirectly between said bottom surface of said polymeric film and said releasable liner. The adhesive layer may comprise a pressure sensitive adhesive. The polymeric film may comprise a material selected from the group consisting of a polyimide, a polyester, a polyetherimide (PEI), a polyethylene naphthalate (PEN), a polyether sulfone (PES), a polysulfone, polymethylpentene (PMP), a polyvinylidenefluoride (PVDF), an ethylene-chlorotrifluoroethylene (ECTFE), or combinations thereof. In some aspects, the polymeric film may comprise at least one polyimide. The polymeric film may comprise at least one facestock polyester. The one or more polyester-isocyanate compounds may comprise the reaction product of an isocyanate and a hydroxylated polyester. The hydroxyl value of the hydroxylated polyester may be greater than 5 mg KOH/g. The hydroxylated polyester may comprise a hydroxyl group-terminated linear or branched polyester. The hydroxylated polyester may have a number average molecular weight of greater than 2000. The topcoat layer may be receptive to or support thermal transfer printing. The label may comprise printed indicia. The printed indicia may comprise a barcode. The topcoat layer may comprise at least one pigment. The topcoat layer may comprise at least one antioxidant. The topcoat layer may comprise at least one matting agent. The matting agent may have an average particle size of less than 10 microns or less than 5 microns.

In another embodiment, the present disclosure is directed to a label comprising (i) a facestock comprising a polymeric film, the polymeric film having a top surface and a bottom surface; and (ii) a topcoat layer comprising one or more polyester-isocyanate compounds, wherein the isocyanate compound is a C₂-C₂₀ linear, branched, cyclic, aromatic, or aliphatic compound, or combinations thereof, wherein the polyester-isocyanate compound has a cross-linking density from 0.9 to 1.4, and said topcoat layer being positioned proximate and/or directly adjacent to at least a portion of the top surface of the polymeric film. The isocyanate compound may be isophorone diisocyanate (IPDI), cyclohexylene diisocyanate, 4,4′-methylenedicyclohexyl diisocyanate (H₁₂MDI); mixed aralkyl diisocyanates, OCN—C(CH₃)₂—C₆H₄C(CH₃) 2-NCO; polymethylene isocyanates, 1,5-pentamethylene diisocyanate, 1,6-hexamethylene diisocyanate (HMDI), 1,7-heptamethylene diisocyanate, 2,2,4-, 2,4,4-trimethylhexamethylene diisocyanate, 1,10-decamethylene diisocyanate, 2-methyl-1,5-pentamethylene diisocyanate, or mixtures thereof. The polyester-isocyanate coating may comprise from 10 to 40 wt. % polyester and from 2 to 20 wt. % isocyanate. The ratio, based on weight percent, of the polyester to the isocyanate may range from 5:1 to 1:5.

### BRIEF DESCRIPTION OF THE DRAWINGS

FIG. 1 illustrates a cross-sectional view of a label according to aspects of the present invention;

FIG. 2 illustrates a plurality of labels according to aspects of the present invention; and

FIG. 3 illustrates a continuous roll of labels according to aspects of the present invention.

### DETAILED DESCRIPTION OF THE INVENTION

The present invention now will be described more fully hereinafter with reference to the accompanying drawings, in which some, but not all embodiments of the inventions are shown. Indeed, this invention can be embodied in many different forms and should not be construed as limited to the embodiments set forth herein; rather, these embodiments are provided so that this disclosure will satisfy applicable legal requirements. As used in the specification, and in the appended claims, the singular forms “a,” “an,” “the,” include plural referents unless the context clearly dictates otherwise.

In one embodiment, the present invention includes polyester-isocyanate coatings that exhibit desirable heat resistance and adhesion to a variety of polymeric materials. Polyester-isocyanate coatings according to certain embodiments of the present invention can also support or are receptive to a variety of printing techniques, including thermal transfer printing. Accordingly, the polyester-isocyanate coatings can beneficially be incorporated onto a variety of labels as an overvarnish or topcoat layer. The present invention, therefore, also provides labels, such as printed circuit board labels and the like, that can receive printed indicia, such as barcodes and the like, and have high heat resistance (e.g., withstand high temperature), chemical resistance (e.g., harsh fluxes, cleaners, saponifier, and wave solder, etc.), and/or scratch resistance.

The present invention beneficially uses isocyanate as a crosslinker for a base polyester, which allows for the use of a base polyester with a greater OH-value. As a result, the cross-linking density of the polyester-isocyanate compound is increased. Additionally, the topcoat may be cured at a lower temperature than other topcoats, has improve flatness and thus less unevenness, and is ultradurable. The improve durability results in anti-abrasion and the topcoat may stay intact even at high temperatures. As described herein, the isocyanate compound refers to a product comprising of one or more polyisocyanate reactive groups. As used herein, the term “polyisocyanate” includes compounds, monomers, oligomers and polymers comprising at least two N═C═O functional groups. Suitable polyisocyanates for use in preparing the isocyanate functional prepolymer of the compositions of the present invention include monomeric, oligomeric and/or polymeric polyisocyanates. The polyisocyanates can be C₂-C₂₀ linear, branched, cyclic, aromatic, aliphatic, or combinations thereof.

Suitable polyisocyanates for use in the present invention may include, but are not limited to, isophorone diisocyanate (IPDI), which is 3,3,5-trimethyl-5-isocyanato-methyl-cyclohexyl isocyanate; hydrogenated materials, such as cyclohexylene diisocyanate, 4,4′-methylenedicyclohexyl diisocyanate (H₁₂MDI); mixed aralkyl diisocyanates, such as tetramethylxylyl diisocyanates, OCN—C(CH₃)₂—C₆H₄C(CH₃)₂—NCO; polymethylene isocyanates, such as 1,4-tetramethylene diisocyanate, 1,5-pentamethylene diisocyanate, 1,6-hexamethylene diisocyanate (HMDI), 1,7-heptamethylene diisocyanate, 2,2,4- and 2,4,4-trimethylhexamethylene diisocyanate, 1,10-decamethylene diisocyanate and 2-methyl-1,5-pentamethylene diisocyanate; and mixtures thereof.

As indicated, in certain embodiments, the polyisocyanate can include an oligomeric polyisocyanate, such as, but not limited to, dimers, such as the uretdione of 1,6-hexamethylene diisocyanate, trimers, such as the biuret and isocyanurate of 1,6-hexanediisocyanate and the isocyanurate of isophorone diisocyanate, allophonates, and polymeric oligomers. Modified polyisocyanates can also be used, including carbodiimides and uretone-imines, and mixtures thereof. Suitable materials include those available under the designation DESMODUR from Bayer Corporation of Pittsburgh, Pa., such as DESMODUR N 3200, DESMODUR N 3300 (hexamethylene diisocyanate trimer), DESMODUR N 3400 (60% hexamethylene diisocyanate dimer and 40% hexamethylene diisocyanate trimer), DESMODUR XP 2410 and DESMODUR XP 2580. DESMODUR N75, DESMODUR N100 (hexamethylene diisocyanate dimer).

In some embodiments, the polyester-isocyanate coating comprises from 10 to 40 wt. % polyester, e.g., from 15 to 35 wt. % polyester, or from 20 to 30 wt. % polyester. In terms of upper limits, the coating comprises at most 40 wt. % polyester, e.g., at most 35 wt. % or at most 30 wt. %. In terms of lower limits, the coating comprises at least 10 wt. % polyester, e.g., at least 15 wt. % or at least 20 wt. %. The polyester-isocyanate coating may also comprise from 2 to 20 wt. % isocyanate, e.g., from 6 to 18 wt. % or from 10 to 16 wt. %. In terms of upper limits, the coating comprises at most 20 wt. % isocyanate, e.g., at most 18 wt. % or at most 16 wt. %. In terms of lower limits, the coating comprises at least 2 wt. % isocyanate, e.g., at least 6 wt. % or at least 10 wt. %. In some aspects, the ratio, based on weight percent, of the polyester to isocyanate may range from 5:1 to 1:5, e.g., from 4:1 to 1:4, from 2:1 to 1:2, or may be substantially equal (from 1.1:1 to 1:1.1) or equal. Optionally, the polyester-isocyanate coating may comprise from 0.01 to 1 wt. % additives, e.g., from 0.05 to 0.9 wt. % or from 0.1 to 0.8 wt. %. In terms of upper limits, the coating comprises at most 1 wt. % additive, e.g., at most 0.9 wt. % or at most 0.8 wt. %. In terms of lower limits, the coating comprises at least 0.01 wt. % additive, e.g., at least 0.05 wt. % or at least 0.1 wt. %.

Due at least in part to the high temperature resistance and strong adhesion on polymeric films, such as polyimide films, the polyester-isocyanate coating layers according to embodiments of the present invention are particularly well suited for topcoat layers for printed circuit board (PCB) labels and other electronic device labeling applications. The polyester-isocyanate coating layers (and labels including a topcoat thereof), for instance, may withstand the high temperatures associated with soldering wave of overflow while also exhibiting strong adhesion to polymeric films, being receptive to printing, and mitigating “yellowing”. In addition, in some embodiments, the adhesive may exhibit a resistance to heat at temperatures of up to 200° C., e.g., up to 225° C., 250° C., 260° C., or 270° C. for time durations of at least 20 seconds, e.g., up to 30 seconds, 50 seconds, 60 seconds, 80 seconds, 100 seconds, or 120 seconds. In some embodiments, by way of example, the adhesive may exhibit a resistance to heat at temperatures from about 200° C. to about 270° C. for at least about 20 seconds to about 120 seconds, including each intermittent temperature and time period.

PCB soldering temperature profile, for example, may include temperature exposures between 240° C. to 250° C. (lead free) and 195° C. to 200° C. (SnPb alloys). As such, the polyester-isocyanate coating compositions (and labels coated with the same) are particularly well suited for incorporation on PCB labels and the like, such as electronic component labeling, motor parts labeling, and other applications.

The term “label” as used herein can comprise an article for attachment to an object, identification of an object, and/or tracking of an object. In accordance with certain embodiments of the present invention, the term “label” may comprise multiple layers, such as 2, 3, 4, 5, 6, or more.

In accordance with certain embodiments, the present invention provides labels, such as printable heat resistant labels, including a facestock comprising a polymeric film. The polymeric film, which may provide strength and substance to the label, includes a top surface and a bottom surface. A topcoat layer comprising a polyester-isocyanate coating containing one or more polyester-isocyanate compounds can be positioned proximate to and/or directly adjacent to at least a portion of the top surface of the polymeric film.

The term “proximate” in the context of the relative positioning of two particular layers of a label includes the positioning of a layer being one or more layers removed from another layer. That is, the term “proximate” in the context of the relative positioning of a first layer and a second layer can mean that the first and second layers are separated by 1, 2, 3, or more intermediate layers (e.g., layers positioned between the first and second layers).

In certain embodiments, the topcoat layer is directly adjacent the top surface of the polymeric film. The topcoat layer may be adapted to support and/or receive printed indicia, such as an ink-image, serial number, barcode, or the like, from a printer or other image-delivering device.

An adhesive layer may be positioned at least proximate and/or directly adjacent to at least a portion of the bottom surface of the polymeric film and may provide a means to attach the label to a variety of objects. The adhesive layer may include an adhesive and, in some embodiments, the adhesive layer may comprise a pressure sensitive adhesive. In certain embodiments, a releasable liner may be positioned adjacent the adhesive layer such that the adhesive layer is disposed, or sandwiched, directly or indirectly between the bottom surface of the polymeric film and the releasable liner. The releasable liner may function as a protective cover/release liner that remains in place until the label is ready for attachment to an object. Moreover, labels according to certain embodiments of the present invention may comprise other layers either above the topcoat layer, between the topcoat layer and the polymeric film, and/or between the polymeric film and the adhesive layer.

As noted previously, labels according to certain embodiments of the present invention may comprise a topcoat layer. Such topcoat layers may comprise a polyester-isocyanate coating containing one or more polyester-isocyanate compounds. In accordance with certain embodiments of the present invention, the one or more polyester-isocyanate compounds may comprise the product from a reaction of an isocyanate and a hydroxylated polyester.

Hydroxylated polyesters as used herein may comprise hydroxyl group-terminated linear or branched polyesters. Any suitable hydroxylated polyester may be used according to certain embodiments of the present invention. For example, suitable hydroxylated polyesters may include polymerized copolyester resins such as VYLON 103, VYLON 200, VYLON 220, VYLON 240, VYLON 270, VYLON 300, VYLON 500, VYLON 226, VYLON 670, and VYLON 550 (all commercially available from Toyobo). Additional exemplary hydroxylated polyesters comprise a range of high-molecular weight and medium-molecular weight copolyesters (e.g., molecular weight ranging from about 2,000 grams per mole to about 20,000 grams per mole), such as DYNAPOL L912, DYNAPOL L952, DYNAPOL L206, DYNAPOL L205, DYNAPOL L208, DYNAPOL L210, DYNAPOL L411, DYNAPOL L850, DYNAPOL L658, DYNAPOL LH815, DYNAPOL LH830, DYNAPOL LH828, and DYNAPOL LH744 (all commercially available from Evonik Degussa). In some aspects, the hydroxylated polyester may have a number average weight of greater than 2000. In some aspects, the hydroxylated polyester may have a hydroxyl resin number of greater than 5 mg KOH/g according to DIN EN ISO 4629, e.g., greater than 15 mg KOH/g, greater than 25 mg KOH/g or 45 mg KOH/g or greater.

As indicated, any suitable isocyanate compounds may be used. The polyisocyanate can include an oligomeric polyisocyanate, such as, but not limited to, dimers, such as the uretdione of 1,6-hexamethylene diisocyanate, trimers, such as the biuret and isocyanurate of 1,6-hexanediisocyanate and the isocyanurate of isophorone diisocyanate, allophonates, and polymeric oligomers. Modified polyisocyanates can also be used, including carbodiimides and uretone-imines, and mixtures thereof. Suitable materials include those available under the designation DESMODUR from Bayer Corporation of Pittsburgh, Pa., such as DESMODUR N 3200, DESMODUR N 3300 (hexamethylene diisocyanate trimer), DESMODUR N 3400 (60% hexamethylene diisocyanate dimer and 40% hexamethylene diisocyanate trimer), DESMODUR XP 2410 and DESMODUR XP 2580. DESMODUR N75, DESMODUR N100 (hexamethylene diisocyanate dimer).

The crosslinking groups of the isocyanate and the crosslinkable groups of the polyester may be provided so that the ratio of equivalents of isocyanate group (—NCO) per equivalent of the crosslinkable group, hydroxyl or imino groups or a combination thereof, herein referred to as “NCO/(OH—NH) ratio”, is from 0.9 to 1.4.

Some of suitable isocyanates include aliphatic, or cycloaliphatic isocyanates, trifunctional isocyanates and isocyanate functional adducts of a polyol and difunctional isocyanates. Some of the particular isocyanates include diisocyanates such as 1,6-hexamethylene diisocyanate, isophorone diisocyanate, biscyclohexyl diisocyanate, ethyl ethylene diisocyanate, 1-methyltrimethylene diisocyanate, and bis-(4-isocyanatocyclohexyl)-methane. For a non-primer layer(s), such as topcoats, non-aromatic isocyanates as described above are preferred. For use in primer layers of a coating, aromatic isocyanates, such as 4,4′-biphenylene diisocyanate, toluene diisocyanate, tetramethylene xylene diisocyanate, 1,3-phenylene diisocyanate, 1,5-napthalene diisocyanate, and 4,4′-diisocyanatodiphenyl ether, may also be used.

Some of the suitable trifunctional isocyanates include triphenylmethane triisocyanate, 1,3,5-benzene triisocyanate, and 2,4,6-toluene triisocyanate. Trimers of diisocyanate, such as the trimer of hexamethylene diisocyante sold under the trademark Desmodur®N-3390 by Bayer Corporation of Pittsburgh, Pa. and the trimer of isophorone diisocyanate are also suitable. Furthermore, trifunctional adducts of triols and diisocyanates are also suitable. Trimers of diisocyanates are preferred and trimers of isophorone and hexamethylene diisocyantes are more preferred. Low viscosity trimers of diisocyanate, such as the one sold under the trademark Desmodur® XP 2410 by Bayer Corporation of Pittsburgh, Pa. are further more preferred. Viscosity of the trimers of diiscyanate is preferably below 1500 mPa·s, more preferably below 1000 mPa·s, and further more preferably at or below 700 mPa·s. Viscosity measurement is based on ASTM test D2196.

The polyester-isocyanate compound may have a crosslinking density from 0.9 to 1.4, e.g., from 0.9 to 1.3 or from 0.9 to 1.2.

The topcoat layer may optionally include one or more fillers and/or additives in amounts described herein. Such fillers and/or additives, for example, may be incorporated into the topcoat layer in conventional quantities using conventional equipment and techniques. For example, representative fillers can include tale, calcium carbonate, organo-clay, glass fibers, marble dust, cement dust, feldspar, silica or glass, fumed silica, silicates, alumina, various phosphorus compounds, ammonium bromide, titanium dioxide, antimony trioxide, antimony trioxide, zinc oxide, zinc borate, barium sulfate, silicones, aluminum silicate, calcium silicate, glass microspheres, chalk, mica, clays, wollastonite, ammonium octamolybdate, intumescent compounds and mixtures of two or more of these materials. The fillers may also carry or contain various surface coatings or treatments, such as silanes, fatty acids, and the like. Still other fillers can include flame retardants, such as the halogenated organic compounds. In certain embodiments, the topcoat layer may include one or more thermoplastic elastomers that are compatible with the other constituents of the topcoat layer, such as hydroxylated polyester, polyester-isocyanate, and other suitable elastomers. In some aspects, the topcoat layer is substantially free, e.g., free of wax ester components, such as those disclosed in US Publication No. 2015/0037572.

The topcoat layer can also include pigment dispersants, such as Nuosperse® 657 available from Elementis Specialties. In accordance with certain embodiments, the topcoat layer may also include carbon pigments, such as carbon black, ivory black, or the like, and/or one or more of a variety of other pigments, such as copper pigments (e.g., phthalocyanine dyes such as phthalocyanine blue), cadmium pigments (e.g. cadmium yellow), chromium pigments (e.g., chrome yellow), cobalt pigments (e.g., cobalt blue), iron oxide pigments (e.g., oxide red), and any other suitable pigments. Any colorants, pigments, and pigment dispersant are suitable to the extent that they do not interfere with desired loadings and/or physical or mechanical properties of the topcoat layer. In some aspects, the pigment is titanium dioxide.

In accordance with certain embodiments, the topcoat layer can also include one or more flow and/or leveling agent to mitigate the occurrence of any surface defects (e.g., formation of pinholes, cratering, peeling, scarring, blistering, air bubbles, etc.). Suitable flow and/or leveling agents utilized are those that do not interfere with desired loadings and/or physical or mechanical properties of the topcoat layer. In certain embodiments, for instance, several commercially available flow and/or leveling agents may be utilized, including, for example BYK-392 (solution of a polyacrylate) from BYK Additives & Instruments; BYK-310 (solution of a polyester modified polydimethylsiloxane) from BYK Additives & Instruments; EFKA 3277 (fluorocarbon modified polyacrylate) from BASF; and/or EFKA 3740 (polyacrylate) from BASF.

The topcoat layer may also include one or more defoaming agents. A defoaming agent generally reduces or mitigates the formation of foaming in the topcoat layer when deposited or generally handled or transferred from one location to another. Generally, any defoaming agent that does not interfere in some embodiments, desired loadings and/or physical or mechanical properties of the topcoat layer may be used. For instance, the defoaming agent may be mineral-based, silicone-based, or non-silicone-based.

In accordance with certain embodiments, the topcoat layer may also include one or more antioxidants. Any suitable antioxidants for a particular embodiment may be used. In some embodiments, antioxidants may be selected that exhibit good heat resistance and mitigate the discoloration of polymeric-based articles/coatings. Exemplary antioxidants suitable for use according to certain embodiments of the present invention include, but not limited to, CHINOX 626, CHINOX 625 (organophophite antioxidant), CHINOX 245 (steric hindered phenolic antioxidant), and CHINOX 30N (blend of hindered phenolic antioxidants), each of which is commercially available from Double Bond Chemical Ind., Co., Ltd.

The topcoat layer may also include one or more matting agents which may facilitate formation of a smooth topcoat layer. Any suitable matting agent for a particular embodiment may be utilized. In some embodiments, the matting agents may have a small particle size. For example, in some embodiments, the matting agents may have a particle size of less than 10 microns on average, e.g., less than 5 microns on average, such as modified or surface treated silica. The silica may be treated a variety of organic polymers depending on the particular resin system employed in the topcoat layer. In certain embodiments, the matting agent may include untreated silicon dioxide.

According to certain embodiments of the present invention, suitable catalyst may also be used. For instance, the constituents of the topcoat may include one or more acid catalysts, such as para-toluene sulfonic acid (PTSA) or methyl sulfonic acid (MSA). Useful acid catalysts may include, by way of example, boric acid, phosphoric acid, sulfate acid, hypochlorides, oxalic acid and ammonium salts thereof, sodium or barium ethyl sulfates, sulfonic acids, and similar acid catalysts. Other useful catalysts, according to certain embodiments, may include dodecyl benzene sulfonic acid (DDBSA), amine blocked alkane sulfonic acid (MCAT 12195), amine blocked dodecyl para-toluene sulfonic acid (BYK 460), and amine blocked dodecyl benezene sulfonic acid (Nacure 5543).

In accordance with certain embodiments of the present invention, the topcoat layer may comprise a variety of different thicknesses. For instance, the topcoat layer may comprise a thickness of from about 2 to about 150 μm, e.g., about 5 to about 100 μm, about 10 to about 75 μm, about 10 to about 50 μm, or 12 to about 25 μm, including each sub-range therein. For example in some embodiments, the top coat layer may have a thickness in the range of 2 to about 100 μm, e.g., 5 to about 50 μm, or 10 to about 25 μm.

The topcoat layer, in accordance with certain embodiments of the present invention, may be applied onto the facestock by any known techniques in the art, such as spray, roll, brush, or other techniques. In some embodiments, the topcoat layer may be coated onto the facestock as a solvent-based system. The amount of carriers and/or solvent's) in the topcoat composition may vary depending on the desired coating viscosity. In accordance with certain embodiments, the solvent(s) may comprise any conventional solvent for polyesters and isocyanate systems. For example, such solvents may include ketones of from 3 to 15 carbon atoms (e.g., methyl ethyl ketone or methyl isobutyl ketone), alkylene glycols and/or alkylene glycol alkyl ethers having from 3 to 20 carbon atoms, acetates and their derivatives, ethylene carbonate, and other suitable solvents. Suitable alcohol solvents include C1 to C8 mono-alcohols, such as methyl, ethyl, propyl, butyl alcohols, as well as cyclic alcohols such as cyclohexanol. In certain embodiments, most acetate-type solvents may be used, such as n-butyl acetate, n-propyl acetate, and other acetate-type solvents. In accordance with certain embodiments, a portion of the solvent system may include water is so desired. In other embodiments, however, the solvent system may be devoid of water.

The final topcoat composition may be calculated by subtracting the solvents from the composition, since the solvents evaporate from the dried topcoat.

As noted above, labels according to embodiments of the present invention may comprise at least one polymeric film. In some embodiments, the polymeric film may comprise any polymeric material that exhibits good mechanical strength and heat resistance. Exemplary polymeric films may comprise at least one of a polyimide, a polyester, a polyetherimide (PEI), a polyethylene naphthalate (PEN), a polyether sulfone (PES), a polysulfone, polymethylpentene (PMP), a polyvinylidene fluoride (PVDF), an ethylene-chlorotrifluoroethylene (ECTFE), or combinations thereof. In certain embodiments, the polymeric film comprises at least one polyimide and in other embodiments, the polymeric film comprises at least one polyester.

Exemplary polymeric films made of polyimide include Kapton®, available from DuPont, and Apical®, available from Kaneka Tex. Corporation. Exemplary polymeric films made of polyester include Mylar®, available from DuPont, and 2600 polyethylene terephthalate film, available from American Hoechst. Other commercially available polymeric films include Tempalux™ (PEI), available from Westlake Plastics Company; Superio-UT™ (PEI), available from Mitsubishi Plastics, Kaladex™; (PEN) and Teonex (PEN), both available from DuPont.

The polymeric films according to certain embodiments of the present invention may comprise a thickness from 2 to 200 μm, e.g., from 5 to 150 μm, from 7 to 125 μm, from 10 to 100 μm, or from 12 to 50 μm, including any sub-ranges therein.

The adhesive layer, according to certain embodiments of the present invention, may comprise any adhesive that is effective in binding the label to an external surface of the object to which the label may be affixed. In some embodiments, the adhesive exhibits good heat resistance and peel strength. For example, in some embodiments the adhesive may exhibit heat resistance at temperatures of up to 200° C., about 225° C., about 250° C., about 260° C., or about 270° C. In some embodiments, the adhesive also may exhibit cohesive strength and high shear resistance. An aggressive pressure sensitive adhesive may be used, such as one of the high-strength or rubber-modified acrylic pressure sensitive adhesives, such as Duro-Tak® 80-115A available from National Starch and Chemical Co. or Aroset™ 1860-Z-45 available from Ashland Specialty Chemical Company. Suitable pressure sensitive adhesives may include, for example, copolymers of alkyl acrylates that have a straight chain of from 4 to 12 carbon atoms and a minor proportion of a highly polar copolymerizable monomer such as acrylic acid. These adhesives are more fully described in U.S. Pat. Re. 24,906 and U.S. Pat. No. 2,973,286, the contents of which are hereby incorporated by reference in their entirety. Alternative pressure sensitive adhesives include ultraviolet curable pressure sensitive adhesives, such as Duro-Tak 4000, which is available from National Starch and Chemical Co.

In accordance with certain embodiments of the present invention, labels may comprise a releasable liner as referenced above. The releasable liner may be positioned directly adjacent to the adhesive layer. In this regard, the releasable liner may protect the adhesive layer before the label is applied (or intended to be applied) to an object or facestock, such as during manufacture, printing, shipping, storage, and at other times. Any suitable material for a releasable liner may be used. Typical and commercially available releasable liners, which can be suitable for embodiments of the present invention, can include a silicone-treated release paper or film, such as those available from Loparex, including products such as 1011, 22533 and 11404, CP Films, and Akrosil™.

As also noted above, the topcoat layer may be receptive to printing of indicia there-through (e.g., pass-through printing) or thereon (e.g., printed indicia resides on the surface of the topcoat layer or within the topcoat layer). For instance, some embodiments of the present invention can be suitable for on-demand printing, such as by thermal transfer printing. Moreover, certain embodiments may comprise printed indicia. The printed indicia may convey or provide a variety of information in the form of words, numbers, patterns, designs, barcodes or other forms of human or machine readable graphics. The printed indicia may be applied to the first or outermost surface of the first or outermost layer of the label, such as the surface open to the environment. The first or outermost layer of labels according to certain embodiments of the present invention may comprise the topcoat layer. In this regard, the printed indicia may be applied by any one of a number of different conventional processes, such as flexographic, letterpress, screen, gravure, photographic printing, or other suitable processes. For print-on-demand applications, a thermal transfer process may apply the print, although other methods can be used, such as dot matrix printing or ink jet printing. For pre-print applications, ultraviolet, aqueous or solvent inks may be used if desired. The information (e.g., printed indicia) may be applied before or after assembly of the complete label. Any suitable chemical composition of the ink or other substance employed to print the information may be used. In some embodiments, the ink or substance should be selected to produce a printed pattern that is compatible the topcoat layer, such as one that adheres sufficiently to the topcoat layer to allow for a reasonable degree of permanency.

In another aspect of certain embodiments, the present invention may provide a form comprising a plurality of labels in which at least one of said labels includes a topcoat layer including one or more polyester-isocyanate compounds (e.g., a polyester-isocyanate coating). The labels may be releasably attached or adhered to a carrier sheet. In this regard, the form including the labels may be processed through an appropriate printer for imparting the desired indicia onto a plurality of the labels at a single time.

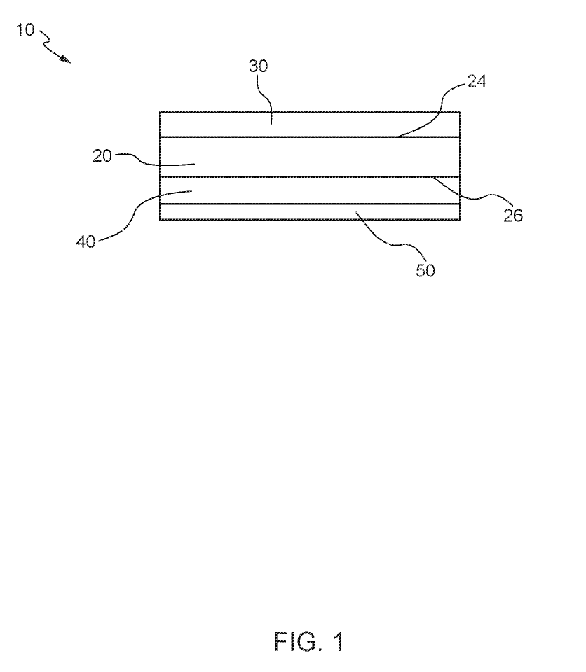

FIG. 1 illustrates a cross-sectional view of a particular label 10 according to certain embodiments of the present invention. The particular embodiment shown in FIG. 1 includes a facestock comprising a polymeric film 20. The polymeric film includes a top surface 24 and a bottom surface 26. Label 10 also includes a topcoat layer 30 comprising one or more polyester-isocyanate compounds. In the embodiment shown in FIG. 1, the topcoat layer 30 is directly adjacent the top surface 24 of the polymeric film 20. An adhesive layer 40 is positioned directly adjacent the bottom surface 26 of the polymeric film 20. This particularly illustrated embodiment also includes a releasable liner 50 positioned directly adjacent the adhesive layer 40 such that said adhesive layer 40 is sandwiched directly between the bottom surface 26 of the polymeric film 20 and said releasable liner 50.

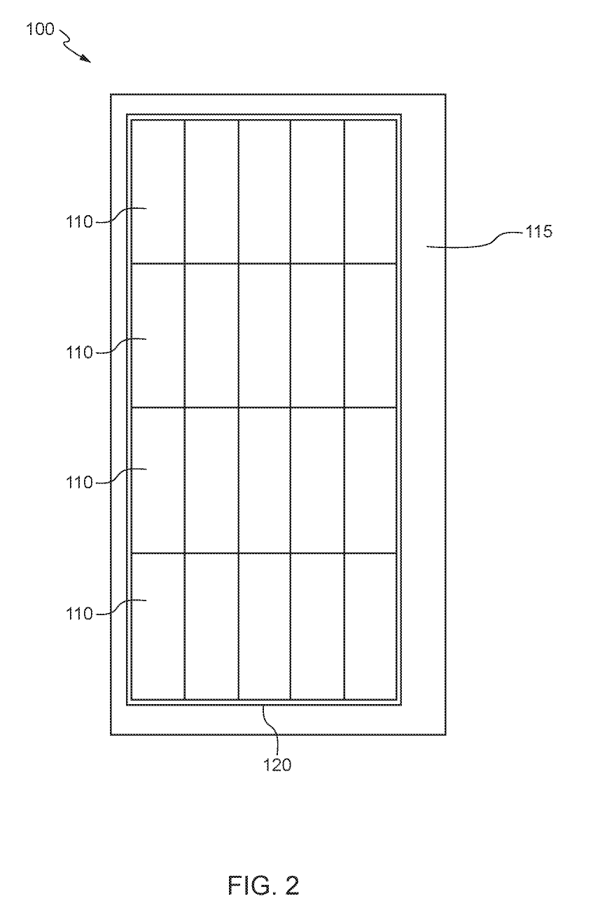

FIG. 2 illustrates a particular form including a plurality of labels according to certain embodiments of the present invention. In particular, FIG. 2 shows an embodiment according to certain embodiments in which form 100 includes a plurality of individual labels 110, according to certain label-embodiments of the present invention, releasably attached or adhered to a carrier sheet 115. In this particular embodiment, the plurality of individual labels 110 are arranged adjacent to each other and form a matrix of labels 120. The form 100 may be processed through a suitable printing or image-producing device to impart printed indicia on the labels 110 at a single time. In this regard, form 100 may be suitable for on-demand printing (e.g., printed at the time or just prior to adhering labels onto a desired object).

In yet another aspect, the present invention includes a continuous roll of labels. The continuous roll of labels can comprise a plurality of labels in which at least one of said labels includes a topcoat layer including one or more polyester-isocyanate compounds, such as a polyester-isocyanate coating. The labels may be releasably attached or adhered to a carrier layer, such as a releasable liner, film, or other carrier layer. In this regard, the form including the labels may be processed through an appropriate printer for imparted the desired indicia onto a plurality of the labels at a single time.

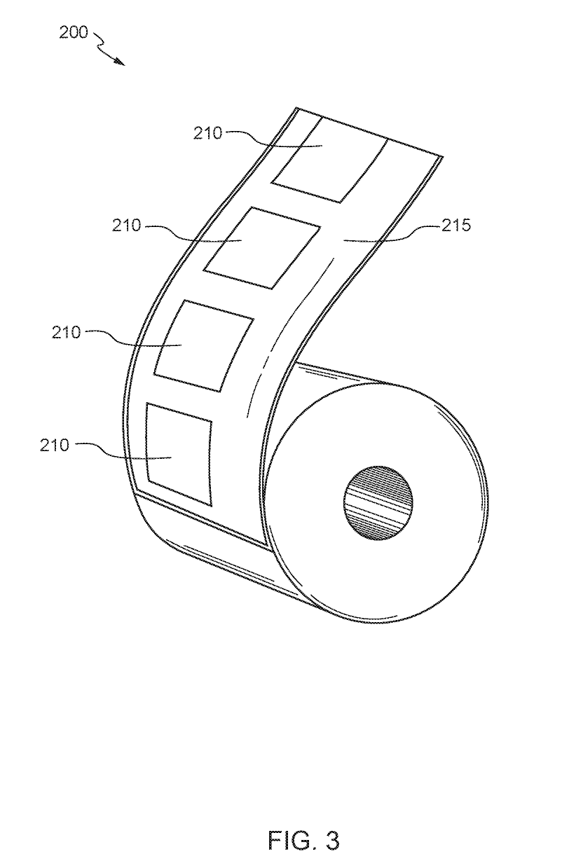

FIG. 3 illustrates a particular continuous roll of labels according to certain embodiments of the present invention. In particular, FIG. 3 shows an embodiment according to certain embodiments in which the continuous roll 200 includes a plurality of individual labels 210, according to certain label-embodiments of the present invention, releasably attached or adhered to a carrier film 215. In this particular embodiment, the plurality of individual labels 110 is serially arranged along the length of the carrier film 215. The continuous roll 200 may be processed through a suitable printing or image-producing device to impart printed indicia on the labels 110 serially. That is, a single label (or more) can be printed at a single time. In this regard, the continuous roll 200 may be suitable for on-demand printing (e.g., printed at the time or just prior to adhering labels onto a desired object).

The following embodiments are contemplated. All combinations of features and embodiments are contemplated.

### Embodiment 1

A label comprising: (i) a facestock comprising a polymeric film, the polymeric film having a top surface and a bottom surface; and (ii) a topcoat layer comprising one or more polyester-isocyanate compounds, wherein the polyester-isocyanate compound has a cross-linking density from 0.9 to 1.4, and said topcoat layer being positioned proximate and/or directly adjacent to at least a portion of the top surface of the polymeric film.

### Embodiment 2

An embodiment of embodiment 1, wherein the topcoat layer has a thickness of from about 2 to 100 μm.

### Embodiment 3

An embodiment of any one of embodiments 1-2, wherein said topcoat layer is directly adjacent said top surface of said polymeric film.

### Embodiment 4

An embodiment of any one of embodiments 1-3, further comprising an adhesive layer positioned at least one of proximate or adjacent to at least a portion of the bottom surface of the polymeric film.

### Embodiment 5

An embodiment of any one of embodiments 1-4, wherein said adhesive layer is directly adjacent said bottom surface of said polymeric film.

### Embodiment 6

An embodiment of any one of embodiments 4-5, further comprising a releasable liner positioned adjacent said adhesive layer such that said adhesive layer is disposed directly or indirectly between said bottom surface of said polymeric film and said releasable liner.

### Embodiment 7

An embodiment of any one of embodiments 4-6, wherein said adhesive layer comprises a pressure sensitive adhesive.

### Embodiment 8

An embodiment of any one of embodiments 1-7, wherein said polymeric film comprises a material selected from the group consisting of a polyimide, a polyester, a polyetherimide (PEI), a polyethylene naphthalate (PEN), a polyether sulfone (PES), a polysulfone, a polymethylpentene (PMP), a polyvinylidenefluoride (PVDF), an ethylene-chlorotrifluoroethylene (ECTFE), or combinations thereof.

### Embodiment 9

An embodiment of any one of embodiments 1-8, wherein the polymeric film comprises at least one polyimide.

### Embodiment 10

An embodiment of any one of embodiments 1-9, wherein the polymeric film comprises at least one facestock polyester.

### Embodiment 11

An embodiment of any one of embodiments 1-10, wherein the one or more polyester-isocyanate compounds comprise the reaction product of an isocyanate and a hydroxylated polyester.

### Embodiment 12

An embodiment of embodiment 11, wherein the hydroxyl value of the hydroxylated polyester is greater than 5 mg KOH/g.

### Embodiment 13

An embodiment of any one of embodiments 11-12, wherein the hydroxylated polyester comprises a hydroxyl group-terminated linear or branched polyester.

### Embodiment 14

An embodiment of any one of embodiments 11-13, wherein the hydroxylated polyester has a number average molecular weight of greater than 2000.

### Embodiment 15

An embodiment of any one of embodiments 1-14, wherein said topcoat layer is receptive to or supports thermal transfer printing.

### Embodiment 16

An embodiment of any one of embodiments 1-15, further comprising printed indicia.

### Embodiment 17

An embodiment of embodiment 16, wherein the printed indicia comprises a barcode.

### Embodiment 18

An embodiment of any one of embodiments 1-17, wherein the topcoat layer further comprises at least one pigment.

### Embodiment 19

An embodiment of any one of embodiments 1-18, wherein the topcoat layer further comprises at least one antioxidant.

### Embodiment 20

An embodiment of any one of embodiments 1-19, wherein the topcoat layer further comprises at least one matting agent.

### Embodiment 21

An embodiment of embodiment 20, wherein the matting agent has an average particle size of less than 10 microns.

### Embodiment 22

An embodiment of embodiment 20, wherein the matting agent has an average particle size of less than 5 microns.

### Embodiment 23

A form, comprising: (i) a plurality of labels according to any one of the preceding claims; and (ii) a carrier sheet, said plurality of labels releasably adhered to the carrier sheet.

### Embodiment 24

A continuous roll of labels, comprising: (i) a plurality of labels according to any of claims 1-22; and (ii) a carrier layer; said plurality of labels are releasably adhered to said carrier layer.

### Embodiment 25

A printed circuit board comprising a label according to any one of embodiments 1-22, adhered to at least one surface of the printed circuit board.

### Embodiment 26

A label comprising: (i) a facestock comprising a polymeric film, the polymeric film having a top surface and a bottom surface; and (ii) a topcoat layer comprising one or more polyester-isocyanate compounds, wherein the isocyanate compound is a C₂-C₂₀ linear, branched, cyclic, aromatic, or aliphatic compound, or combinations thereof, wherein the polyester-isocyanate compound has a cross-linking density from 0.9 to 1.4, and said topcoat layer being positioned proximate and/or directly adjacent to at least a portion of the top surface of the polymeric film.

### Embodiment 27

An embodiment of embodiment 26, wherein the isocyanate compound is isophorone diisocyanate (IPDI), cyclohexylene diisocyanate, 4,4′-methylenedicyclohexyl diisocyanate (H₁₂MDI); mixed aralkyl diisocyanates, OCN—C(CH₃)₂—C₆H₄C(CH₃)₂—NCO; polymethylene isocyanates, 1,5-pentamethylene diisocyanate, 1,6-hexamethylene diisocyanate (HMDI), 1,7-heptamethylene diisocyanate, 2,2,4-, 2,4,4-trimethylhexamethylene diisocyanate, 1,10-decamethylene diisocyanate, 2-methyl-1,5-pentamethylene diisocyanate, or mixtures thereof.

### Embodiment 28

An embodiment of any one of embodiments 26-27, wherein the polyester-isocyanate coating comprises from 10 to 40 wt. % polyester and from 2 to 20 wt. % isocyanate.

### Embodiment 29

An embodiment of any one of embodiments 26-28, wherein the ratio, based on weight percent, of the polyester to the isocyanate is from 5:1 to 1:5.

The present invention will be better understood in view of the following non-limiting examples.

### EXAMPLES

### Example 1

A topcoat layer was prepared by combining the polyester component and solvents and then dispersing the pigments, crosslinker, catalyst and additives into a compounding solution.

TABLE 1
Topcoat layer Compounding Solution

| Component | Weight (g) |
|---|---|
| Hydroxylated polyester (OH value of 45) | 1500 |
| Mixture solvents: 40:40:20 ratio | 1500 |
| solvesso 150 [a] | |
| DBE [b]:PMA [c] | |
| Diluted solvents: solvesso 100 [d]:PMA: | 1200 |
| in a 50:50 ratio | |
| TiO₂ (pigment) | 1800 |
| N75 [e] | 340 |
| TIN-22 [f] | 0.6 |
| BYK-170 [g] | 30 |
| BYK-392 [h] | 10 |

[a] mixing solvent from Exxon Mobil Chemical
[b] dibasic acid esters solvent
[c] Propylene Glycol Monomethyl Ether Acetate
[d] mixing solvent from Exxon Mobil Chemical
[e] Polyisocyanate resin from Bayer
[f] organic Tin catalyst form Elementis
[g] dispersing agent from BYK

The final topcoat composition may be calculated by subtracting the solvents from the composition, e.g., by subtracting the 1500 gram mixture of solvents and the 1200 gram diluted solvents.

The topcoat layer was cast and co-extruded with a facestock comprising a polymeric film. The thickness of the topcoat layer was 15 μm. The polyester-polyisocyanate compound had a cross-linking density of 0.95.

### Example 2

A topcoat layer was prepared as in Example 1, except that an aliphatic polyisocynate resin based on biuret-modified hexamethylene diisocyante (Basonat HB175, sold by BASF) was used as the polyisocyanate resin.

### Comparative Example A

A topcoat layer was prepared as in Example 1, except that a polyfunctional aziridine liquid cross-linker (CX-100 sold by DSM Coating Resins LLC) was used as a crosslinker. The topcoat layer could not be formed because the CX-100 resin could not react with the OH resin.

### Comparative Example B

A topcoat layer was prepared as in Example 1, except that the hydroxylated polyester had a hydroxyl number of 5 and the crosslinker was N75.

### Testing

The topcoats of the labels prepared according to Examples 1 and 2 and Comparatives Example A and B were tested by placing each sample on a thin aluminum panel for 20 minutes. The panel with the label samples thereon was then placed into a preheated oven at the temperatures reported in Table 2 for 5 minutes. The panel was removed from the oven after 5 minutes and then cooler at and to room temperature.

TABLE 2
Heat Resistance Results of the Topcoat

| Temperature | | | | |
|---|---|---|---|---|
| Exposure for | | | | |
| 5 Minutes | | | Comparative | Comparative |
| (° C.) | Example 1 | Example 2 | Example A | Example B |
| 220 | No visible | No visible | Slight | No visible |
| | effect | effect | yellowing | effect |
| 240 | No visible | No visible | Slight | No visible |
| | effect | effect | yellowing | effect |
| 260 | No visible | No visible | Slight | No visible |
| | effect | effect | yellowing | effect |
| 280 | No visible | No visible | Yellowing | No visible |
| | effect | effect | | effect |
| 300 | No visible | No visible | Yellowing | Slight |
| | effect | effect | | yellowing |
| 320 | Slight | Slight | Yellowing | Yellowing |
| | yellowing | yellowing | | |

As shown by the results above, the topcoat layer comprising the polyester-isocyanate compound of the present invention had surprising and unexpected heat resistance to at least 300° C. as compared to a topcoat layer with a different polyester compound.

These and other modifications and variations to the present invention may be practiced by those of ordinary skill in the art without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

1. A label comprising:
(i) a facestock comprising a polymeric film, the polymeric film having a top surface and a bottom surface; and
(ii) a topcoat layer comprising one or more polyester-isocyanate compounds, wherein the polyester-isocyanate compound has a cross-linking density from 0.9 to 1.4, and said topcoat layer being positioned proximate and/or directly adjacent to at least a portion of the top surface of the polymeric film.

2. The label according to claim 1, wherein the topcoat layer has a thickness of from about 2 to 100 μm.

3. The label according to claim 1, wherein said topcoat layer is directly adjacent said top surface of said polymeric film.

4. The label according to claim 1, further comprising an adhesive layer positioned at least one of proximate or adjacent to at least a portion of the bottom surface of the polymeric film.

5. The label according to claim 1, wherein said adhesive layer is directly adjacent said bottom surface of said polymeric film.

6. The label according to claim 4, further comprising a releasable liner positioned adjacent said adhesive layer such that said adhesive layer is disposed directly or indirectly between said bottom surface of said polymeric film and said releasable liner.

7. The label according to claim 4, wherein said adhesive layer comprises a pressure sensitive adhesive.

8. The label according to claim 1, wherein said polymeric film comprises a material selected from the group consisting of a polyimide, a polyester, a polyetherimide (PEI), a polyethylene naphthalate (PEN), a polyether sulfone (PES), a polysulfone, a polymethylpentene (PMP), a polyvinylidenefluoride (PVDF), an ethylene-chlorotrifluoroethylene (ECTFE), or combinations thereof.

9. The label according to claim 1, wherein the polymeric film comprises at least one polyimide.

10. The label according to claim 1, wherein the polymeric film comprises at least one facestock polyester.

11. The label according to claim 1, wherein the one or more polyester-isocyanate compounds comprise the reaction product of an isocyanate and a hydroxylated polyester.

12. The label according to claim 11, wherein the hydroxyl value of the hydroxylated polyester is greater than 5 mg KOH/g.

13. The label according to claim 11, wherein the hydroxylated polyester comprises a hydroxyl group-terminated linear or branched polyester.

14. The label according to claim 11, wherein the hydroxylated polyester has a number average molecular weight of greater than 2000.

15. (canceled)

16. The label according to claim 1, further comprising printed indicia.

17. The label according to claim 16, wherein the printed indicia comprises a barcode.

18. The label according to claim 1, wherein the topcoat layer further comprises at least one pigment, at least one antioxidant, and/or at least one matting agent.

19-25. (canceled)

26. A label comprising:
(i) a facestock comprising a polymeric film, the polymeric film having a top surface and a bottom surface; and
(ii) a topcoat layer comprising one or more polyester-isocyanate compounds, wherein the isocyanate compound is a C2-C20 linear, branched, cyclic, aromatic, or aliphatic compound, or combinations thereof, wherein the polyester-isocyanate compound has a cross-linking density from 0.9 to 1.4, and said topcoat layer being positioned proximate and/or directly adjacent to at least a portion of the top surface of the polymeric film.

27. The label of claim 26, wherein the isocyanate compound is isophorone diisocyanate (IPDI), cyclohexylene diisocyanate, 4,4′-methylenedicyclohexyl diisocyanate (H12MDI); mixed aralkyl diisocyanates, OCN—C(CH3)2-C6H4C(CH3)2-NCO; polymethylene isocyanates, 1,5-pentamethylene diisocyanate, 1,6-hexamethylene diisocyanate (HMDI), 1,7-heptamethylene diisocyanate, 2,2,4-, 2,4,4-trimethylhexamethylene diisocyanate, 1,10-decamethylene diisocyanate, 2-methyl-1,5-pentamethylene diisocyanate, or mixtures thereof.

28. The label of claim 26, wherein the polyester-isocyanate coating comprises from 10 to 40 wt. % polyester and from 2 to 20 wt. % isocyanate.

29. (canceled)
